(19) United States
(12) Patent Application Publication
(10) Pub. No.: US 2012/0207411 A1
(43) Pub. Date: Aug. 16, 2012

(54) SHOPPING BAG

(76) Inventor: Claude Roessiger, Wolfeboro, NH (US)

(21) Appl. No.: 13/227,770

(22) Filed: Sep. 8, 2011

Related U.S. Application Data
(63) Continuation-in-part of application No. 13/025,067, filed on Feb. 10, 2011.

(51) Int. Cl. B65D 30/16; B31B 31/00; B65D 33/06

(52) U.S. Cl. 383/104; 383/16; 493/243

(57) ABSTRACT

An unassembled bag made of a creased piece of paper having top and bottom parallel horizontal sides, right and left vertical sides, a bottom left and right corners, left, middle, and right parallel vertical creases, top and bottom horizontal creases, right, middle, and left intersections, right and left two side creases parallel to the vertical creases, right and left side crease termini, four diagonal creases between the bottom horizontal crease and side, a front panel flange crease, a front panel flange intersection, and a front panel flange with an interior and an exterior, one of which has adhesive.

### CLAIM OF PRIORITY

This application is a continuation in part of co-pending U.S. Non-Provisional patent application Ser. No. 13/025,067, filed on Feb. 10, 2011.

### FIELD OF THE INVENTION

The present invention relates to shopping bags, and in particular, to shopping bags with no back face crease, that are thin when folded.

### BACKGROUND

Shopping bags are commonly used the world over as receptacles for purchased items. They come in many sizes, colors, and patterns. FIGS. 1A-1C show a typical prior art shopping bag 2 open in a perspective view, folded in a side view, and folded in a back view, respectively. Solid lines depict edges of prior art shopping bag 2 and dashed lines depict creases of prior art shopping bag 2. Prior art shopping bag 2 includes bottom flap 4, gusseting 6, bottom flap crease 8, handle 10, back panel 12, and front panel 14. Gusseting 6 allows shopping bag 2 to be expanded from a folded position, as shown in FIGS. 1B and 1C, to an open position, as shown in FIG. 1A. When folded, bottom flap 4 covers part of back panel 12 as it folds up over bottom flap crease 8. When expanded and open, prior art shopping bag 2 may rest upright with bottom flap 4 on the ground.

Although such a prior art shopping bag 2 is widely used, it suffers from at least three major disadvantages. First, as shown in FIG. 1B, because of how back panel 12 folds at bottom flap crease 8, prior art shopping bag 2 does not have uniform thickness when it is folded. At thick area 16, folded prior art shopping bag 2 has four layers of paper. As many stores, especially luxury or higher end stores, use thick, quality paper in their shopping bags, prior art shopping bag 2 can be quite thick through the thick area 16. Moreover, as prior art shopping bag 2 is not uniformly thick, stacking and storing large quantities of prior art shopping bags 2 is awkward. The second major disadvantage of prior art shopping bag 2 is that when opened or erected, the crease shows on the back panel 12. Back panel 12 is an area that may be used for marketing and advertising, and it is therefore advantageous for it to be fully exposed at all times. Finally, especially with bags made from less thick, lighter paper, even when open, prior art shopping bag 2 may list because it is difficult to fully straighten back panel 12 because of bottom flap crease 8.

Some efforts have been made to address some of these disadvantages. Barney's New York, for example, uses a shopping bag that does not include a fold or bottom panel4. Although this means that the shopping bag lies much more flat that prior art shopping bag 2 shown in FIGS. 1A-1C and the front and back panels of the shopping bag are fully exposed at all times, this shopping bag also has its disadvantages: With no bottom panel 4, it cannot sit upright, and although it does include gusseting 6, it cannot expand very much, especially at the bottom.

Therefore there is a need for a paper shopping bag that includes the advantages of the prior art in that it includes a bottom panel 4, so that the shopping bag may sit upright when open and has plenty of room to expand, but overcomes the disadvantages of the prior art in that it lies flat, has front and back panels that are never covered by a bottom panel when folded, and does not include a crease on either front or back panel, such as bottom flap crease 8, that will tend to make the shopping bag list.

### SUMMARY OF THE INVENTION

The present invention includes three unassembled bags, and an assembled bag.

In its most basic form the first unassembled bag of the present invention is a creased piece of paper including top and bottom parallel horizontal sides that are perpendicular to right and left vertical sides; a bottom left corner where the bottom horizontal side meets the left vertical side; a bottom right corner where the bottom horizontal side meets the right vertical side; left, middle, and right parallel vertical creases; top and bottom horizontal creases; right, middle, and left intersections where the right, middle, and left vertical creases and bottom horizontal crease meet; right and left side creases parallel to the vertical creases; right and left side crease termini where the right and left side creases and the bottom horizontal side meet; four diagonal creases spanning between the bottom horizontal crease and the bottom horizontal side; a front panel flange crease parallel and adjacent to one of the vertical sides; a front panel flange intersection where the front panel crease and the bottom horizontal side meet; and a front panel flange with an interior and an exterior, one of which has adhesive. The creased paper may be made of any type of foldable paper or cardboard, but is preferably made of those types of paper commonly used to manufacture shopping bags, especially the thick, high quality paper often used to manufacture shopping bags for high end or luxury stores. The creased paper may be assembled to form a bag that may sit upright when open and may lie essentially flat when folded. It is understood that for features of the present invention, such as various creases and sides, to be considered “adjacent,” the features must be parallel to one another and there must not be another parallel feature between the adjacent features.

Each crease in the creased paper is either an “away” crease or a “toward” crease. That is to say that when one views one side of the creased paper, an away crease is creased so that the point of the crease points away from the viewer, and a toward crease is creased so that the point of the crease points toward the viewer. All creases herein designated as away or toward are done so based upon the assumption that the viewer is viewing the creased paper's interior side, or the side that would be the interior of the bag if the creased paper were assembled into a bag. It is understood that if the viewer were viewing the creased paper's exterior side, or the side that would be the exterior of the bag if the creased paper were assembled into a bag, then the away or toward designations would be reversed.

The creases of the creased paper delineate what will be front and side panels of the bag that may be formed from the creased paper. Front panels are generally larger than side panels, although side panels may be up to the same size as front panels. Front panels are flat, while side panels have a crease in the middle for gusseting purposes. The first front panel is formed between the top horizontal crease, the bottom horizontal crease, and two adjacent vertical creases. Depending on the configuration of the creased paper, these may be the left and middle vertical creases, or the middle and right vertical creases. The second front panel is formed between the top horizontal crease, the bottom horizontal crease, the vertical crease that does not form the first front panel, and whatever vertical feature is adjacent to that vertical crease that is not a side crease. This vertical feature may be a vertical side, a front panel flange crease, or a fourth vertical crease. Side panels are formed around side creases and between front panels. The right and left side creases are the creases in the middle of side panels. In all configurations of the creased paper, one side panel is roughly in the middle of the creased paper between the two front panel sections. The other side panel may be on either the extreme left or right of the creased paper. It may also be on the extreme left or right of the creased paper but for the front panel flange. It may also be divided so that one half of the side panel is on the extreme left or right of the creased paper and the other half is on the other extreme side, but for the front panel flange.

The front panel flange is a flange that protrudes from a vertical crease, either a right or left vertical crease or a right or left side crease, of the creased paper and will be adhered to another side or crease of the creased paper to form the body of the bag. The front panel flange therefore creates an adhesive seam. This seam can be located in several places. In a first embodiment, the front panel flange is on the right between the right vertical side and the right side crease so that the front panel flange crease and the right side crease are the same toward crease. In this embodiment, the first front panel is formed between the middle and right vertical creases; the second front panel is formed between the left vertical crease and a fourth vertical crease adjacent to the left vertical side; and a side panel is split with half of it between the left vertical side and the fourth vertical crease, and half of it between the front panel flange crease/right side crease and the right vertical side. The mirror image of this configuration is another embodiment: The front panel flange is on the left between the left vertical side and the left side crease so that the front panel flange and the left side crease are the same toward crease. In each of these first mirror image configurations, the adhesive seam will be in the center of one of the side panels of the bag when the creased paper is assembled into a bag.

In a second embodiment, the front panel flange is an away crease on the right between the right vertical side and the right vertical crease, but the front panel flange crease is not the same as a side crease. In this embodiment, the first front panel is formed between the left and middle vertical creases; the second front panel is formed between the right vertical crease and the front panel flange crease; and a side panel is formed on the extreme left between the left vertical side and the left vertical crease. Again, the mirror image of this configuration is another embodiment: The front panel flange is on the left between the left vertical side and the left vertical crease, but the front panel flange crease is not the same as a side crease. In each of these second mirror image configurations, the adhesive seam will be between a front panel and a side panel because the front panel flange is protruding from a front panel and being adhered to a side panel. In each of the first and second embodiments discussed above, the front panel flange is being adhered to a half of a side panel that includes a diagonal crease at its bottom. In these configurations, therefore, the front panel flange also includes a partial diagonal crease at its bottom so as to conform with the side panel and its diagonal crease. In some embodiments, the front panel flange is commensurate with half of a side panel, so it includes a full diagonal crease that conforms with the side panel's diagonal crease. Therefore, it is understood that a “partial diagonal crease” may be as long as the first through fourth diagonal creases.

In a third embodiment, the front panel flange crease is on the right between the right side crease and the right vertical side. In this embodiment, the first front panel is formed between the middle and right vertical sides; the second front panel is formed between the left vertical side and the left vertical crease; and a side panel is on the extreme right but for the front panel flange. Again, the mirror image of this configuration is another embodiment: The front panel flange is on the left between the left side crease and the left vertical side. In each of these third mirror image configurations, the adhesive seam will again be between a front panel and side panel, this time because the front panel flange is protruding from a side panel and being adhered to a front panel. In this embodiment, as the front panel flange is being adhered to a front panel that does not include a diagonal crease, there is no need for the front panel flange to include coinciding partial diagonal creases.

In preferred embodiments of the present invention, the unassembled bag also includes a bottom reinforcement. The bottom reinforcement is approximately the same area as what the bottom of the bag will be, which is twice the area of the space defined by two adjacent vertical creases, the bottom horizontal side, and the bottom horizontal crease. The bottom reinforcement is connected to a bottom reinforcement flange, which is adhered to just above the bottom horizontal crease. The bottom reinforcement and the bottom reinforcement flange are separated by an away bottom reinforcement crease that conforms with the bottom horizontal crease.

In preferred embodiments of the present invention, the unassembled bag also includes a bottom panel flange protruding from the bottom horizontal side. This is not to be confused with the bottom reinforcement flange, which adheres the bottom reinforcement to the creased paper. The bottom panel flange adheres the creased paper to itself to form the bottom panel on which the bag will sit. The bottom panel flange may be positioned below either front panel. That is to say, depending on the configuration of the front panel flange, the bottom panel flange may be positioned between the middle and right vertical creases; the middle and left vertical creases; the left vertical crease and a fourth vertical crease adjacent to the left vertical side; the right vertical crease and a fourth vertical crease adjacent to the right vertical side; the front panel flange crease and the left vertical crease; the front panel flange crease and the right vertical crease; the left vertical side and the left vertical crease; and the right vertical side and the right vertical crease. The bottom panel flange includes an exterior side and an interior side, one of which includes a bottom panel flange adhesive. If the bottom panel flange adhesive is on the interior of the creased paper, then the flange will be visible on the bottom of the exterior of the bag that may be assembled from the creased paper.

It is therefore preferred that the bottom panel flange adhesive be on the exterior of the bottom panel flange, so that the bottom panel flange is tucked into the interior of the bag during assembly and is therefore not visible from the exterior of the bag. In one such embodiment, the bottom panel flange adhesive is an adhesive strip, i.e. a strip of adhesive, usually some type of glue, that is covered with a non-adhesive strip until directly prior to adhesion, when the non-adhesive strip is peeled away to reveal the strip of adhesive which is then adhered to something else. It is preferred that the adhesive strip be as long as the bottom panel flange, but not as wide, and that it be positioned adjacent to the bottom horizontal side. This avoids any unsightly adhesive seeping through the seam because if it does stray, it will only stray farther along the bottom panel flange, rather than to the exterior of the bag.

In some embodiments of the unassembled bag, particularly those made with stiff or thick paper, the diagonal creases of the creased paper may be perforated, in addition to being creased.

Preferred embodiments of the unassembled bag also include top reinforcements positioned below the top horizontal crease and handles positioned so that they are attached to the creased paper at the top reinforcements. Top reinforcements are preferably thin rectangular pieces of cardboard, but may be any shape and may be any of a range of thicknesses. Although thin rectangular cardboard top reinforcements are preferred, the top reinforcements may be made of paper, either the same paper as the bag is itself manufactured out of or other paper.

The handles may be cut into the top of the front panels so that they are essentially holes in the top of the front panels. They may be cord, string, wire, ribbon, rope, thread, or any other type of string, whose ends are adhered to the interior of the front panels. They may be pieces of string that are tied in knots at their ends and threaded through holes in the front panels. These are but a few examples of the many handles commonly used in the art of shopping bags that are contemplated as falling within the scope of the present invention. Regardless of the type of handles, it is preferable that the bag be reinforced where the handles meet the front panel. This reinforcement may be by folding the creased paper at the top horizontal crease, including top reinforcements, or both.

The second unassembled bag of the present invention includes two pieces of creased paper that may be assembled into a bag. Such a two piece assembly would likely be used for larger bags, although it may be used for any sized bag. Many of the features of the first creased paper kit are in common with the creased paper of the present invention. Each piece includes left and right vertical sides, top and bottom horizontal sides, bottom right and left corners, top and bottom horizontal creases, left and right intersections where the left and right vertical creases meet the bottom horizontal crease, a front panel flange formed by a front panel flange crease, positioned on one side of the piece, a front panel intersection where the front panel flange crease meets the bottom horizontal side, and two diagonal creases spanning diagonally between the bottom horizontal crease and the bottom horizontal side. The front panel flanges on either the left or right sides of the two pieces will adhere to the other piece at what will become a side panel when the creased papers are assembled into a bag. In the preferred embodiment, this makes the adhesive seam along the center of the side panel. As discussed above, in this preferred embodiment, as the front panel flange is being adhered to a side panel, it must include a partial diagonal crease to conform with the diagonal creases of the side panels.

In a second embodiment of the two piece unassembled bag, each piece includes only a one vertical crease, and also includes a side toward crease adjacent to the vertical crease and the front panel flange crease. This second embodiment encompasses two mirror images. In the first mirror image, the left vertical side is adjacent to the vertical crease, which is adjacent to the side crease, which is adjacent to the front panel flange crease, which is adjacent to the right vertical side, so that the front panel flange is on the right. In the second mirror image, the left vertical side is adjacent to the front panel flange, which is adjacent to the side crease, which is adjacent to the vertical crease, which is adjacent to the right vertical side, so that the front panel flange crease is on the left. In these embodiments, the side panels are not split, and the front panel flanges extend from the side panels for attachment to the front panels, so the front panel flanges do not include partial diagonal creases.

In a third embodiment of the two piece unassembled bag, each piece also includes only a one vertical crease, one side toward crease adjacent to the vertical crease, and the front panel flange crease. This third embodiment also encompasses two mirror images. In the first mirror image, the left vertical side is adjacent to the front panel flange crease, which is adjacent to the vertical crease, which is adjacent to the side crease, which is adjacent to the right vertical side, so that the front panel flange is on the left. In the second mirror image, the left vertical side is adjacent to the side crease, which is adjacent to the vertical crease, which is adjacent to the front panel flange crease, which is adjacent to the right vertical side, so that the front panel flange crease is on the right. In these embodiments, the side panels are not split, and the front panel flanges extend from the front panels for attachment to the side panels, so the front panel flanges include partial diagonal creases.

The third unassembled bag of the present invention includes four pieces of creased paper that may be assembled into a bag. Such a four piece assembly would also likely be used for larger bags, although it may be used for any sized bag. The four piece creased paper kit includes two panel pieces, two side pieces, and four attachment flanges that will be integral to either side of the two panel pieces, either side of the two side pieces, or the right or left sides of the two panel pieces and two side pieces. When the attachment flanges are attached only to side pieces or panel pieces, each set of attachment flanges includes a right attachment flange and a left attachment flange. The right attachment flange will be integral to either the right side of each side piece or the right side of each panel piece. The right attachment flange includes a right side that will be the far right side of the combination of the attachment flanges with either a side or panel piece, and a left attachment side that shares a toward crease with the right side of the side or panel piece. The left attachment flange includes a left side that will be the far left side of the combination of the attachment flanges with either a side or panel piece, and a right attachment side that shares a toward crease with the left side of the side or panel piece. When the attachment flanges are integral to the panel pieces, they include partial diagonal creases to conform with the diagonal creases of the side pieces. When the four attachment flanges are attached to the left sides of each of the four pieces, the attachment flanges each include a left side and a right attachment side, and the two attachment flanges attached to the panel pieces for attachment to the side pieces include partial diagonal creases. When the four attachment flanges are attached to the right sides of the four pieces, the attachment flanges each include a right side and a left attachment side, and the two attachment flanges attaches to the panel pieces for attachment to the side pieces include partial diagonal creases.

The bag of the present invention includes an exterior, an interior, a front panel, a back panel, two side panels, and a bottom panel. The front, back, and side panels include top sections that are folded over into the interior of the bag. This creates a top fold. The top fold includes a centered slit cut into the fold. The bag also includes an integrated handle and top reinforcement with a handle section, a handle width, a top reinforcement section, and a top reinforcement width. The integrated handle and top reinforcement is designed to slide through the centered slit to provide handles for the bag. The centered slit is wider than the handle width so that the handle section may move through the centered slit, but is narrower than the top reinforcement width so that the top reinforcement section cannot move through and is caught by the centered slit. Being able to insert the handles into the bag decreases the size necessary for shipping the bags. This type of handle may be used in conjunction with any of the unassembled bags of the present invention as described above.

Therefore it is an aspect of the present invention to provide an unassembled bag that may be formed into a bag with adhesive seams at any of several positions.

It is a further aspect of the present invention to provide an unassembled bag that may be assembled into a bag that includes a bottom reinforcement and a bottom reinforcement flange that is adhered to the interior of a front panel of the bag.

It is a further aspect of the present invention to provide an unassembled bag that may be assembled into a bag that is assembled in part by a bottom panel flange that may be in any of several positions.

It is a further aspect of the present invention to provide an unassembled bag that may be assembled into a bag that includes a bottom panel flange with a strip adhesive that will not be on the exterior of the assembled bag.

It is a further aspect of the present invention to provide a two piece unassembled bag that may be assembled into a bag.

It is a further aspect of the present invention to provide a four piece unassembled bag that may be assembled into a bag.

It is a further aspect of the present invention to provide a bag with top reinforcements and several different types of handles.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1A is a perspective view of an open prior art shopping bag.

FIG. 1B is a side view of a folded prior art shopping bag.

FIG. 1C is a back view of a folded prior art shopping bag.

FIGS. 2A-2C show the creased paper of the present invention with the glue seam in various positions.

FIG. 3 shows a bottom reinforcement of the present invention.

FIG. 4 shows details of a preferred bottom panel flange.

FIG. 5A shows one embodiment of the two piece unassembled bag of the present invention.

FIG. 5B shows an alternative embodiment of the two piece unassembled bag of the present invention.

FIG. 5C shows an alternative embodiment of the two piece unassembled bag of the present invention.

FIG. 6A shows one embodiment of the four piece unassembled bag of the present invention.

FIG. 6B shows an alternative embodiment of the four piece unassembled bag of the present invention.

FIG. 6C shows an alternative embodiment of the four piece unassembled bag of the present invention.

FIG. 7 shows a bag of the present invention with a string handle.

FIG. 8A is a perspective view of the bag of the present invention.

FIG. 8B is an alternative perspective view of the bag of the present invention.

FIG. 8C shows an integrated handle and top reinforcement.

FIG. 8D is a top down view of a non-folded front panel of a bag of the present invention with a centered slit.

FIG. 8E is a side view of a front panel of a bag of the present invention showing a top fold.

FIG. 8F is a top down view of an interior front panel of the bag of the present invention with an integrated handle and top reinforcement partially within the bag.

FIG. 8G is a top down view of an interior front panel of the bag of the present invention with an integrated handle and top reinforcement in position with the handle protruding out of the bag through the centered slit.

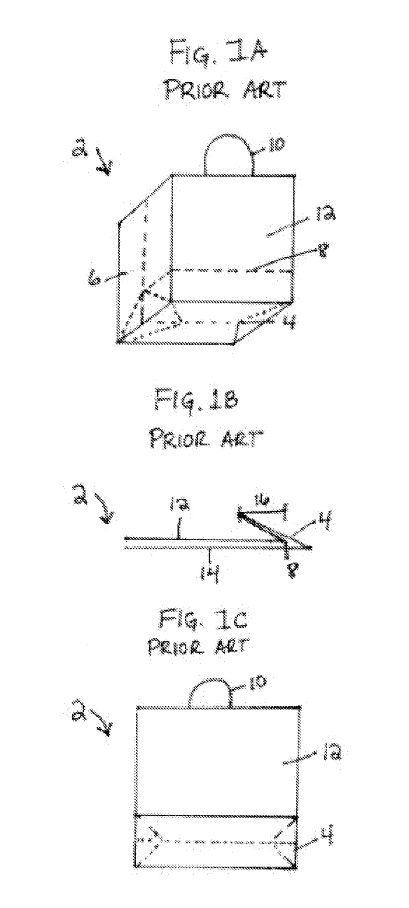

### DETAILED DESCRIPTION

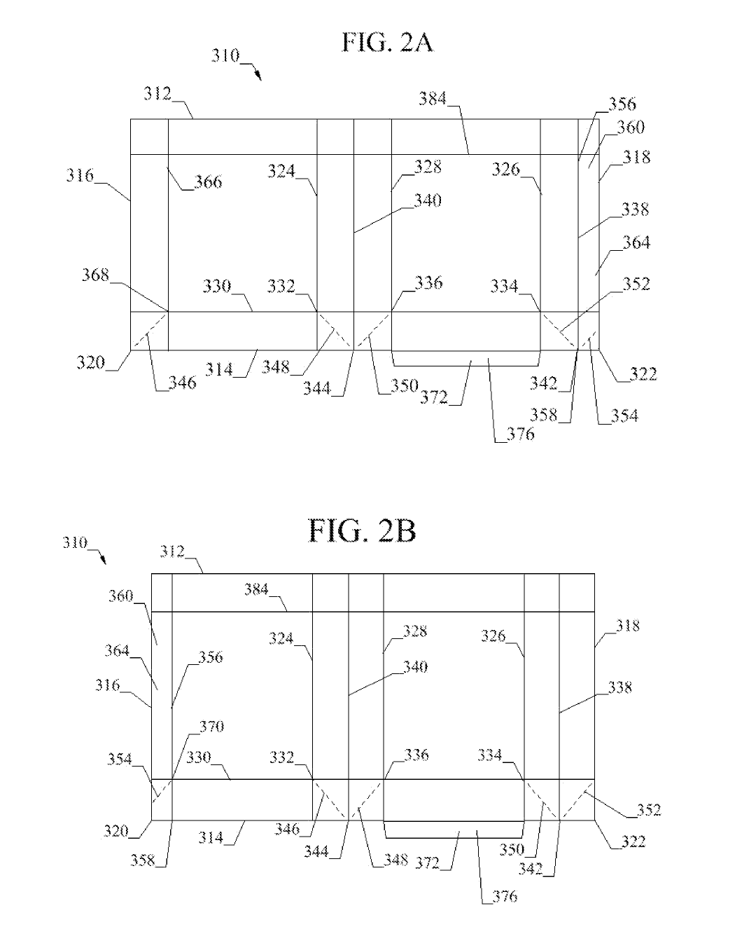

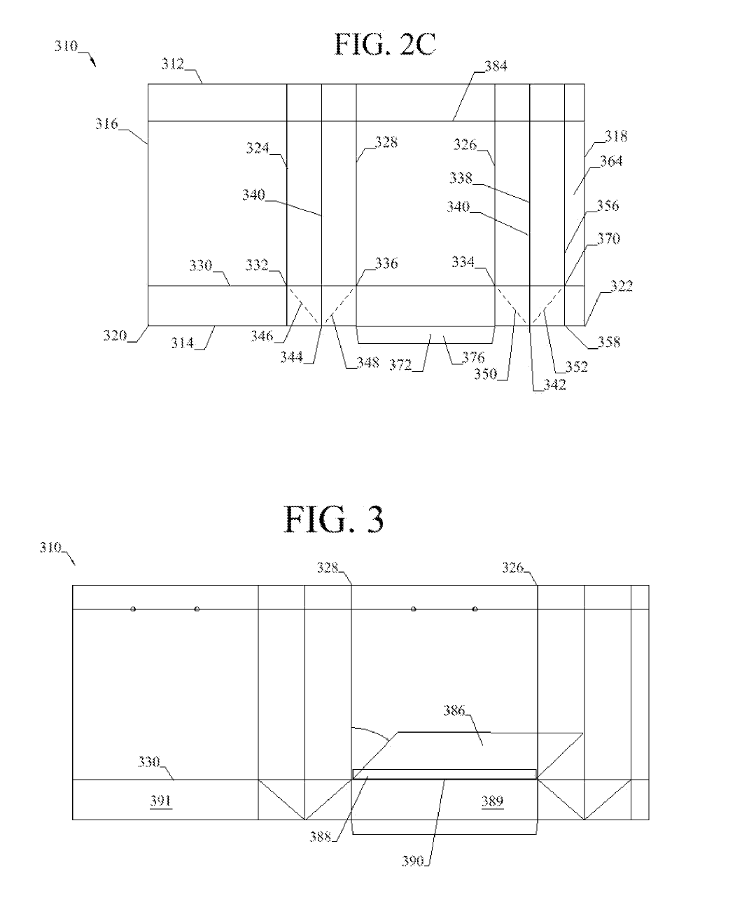

Referring first to FIGS. 2A-2C, several embodiments of creased paper 310 of the present invention with different adhesive seam positions are shown. Each includes top horizontal side 312, bottom horizontal side 314, left vertical side 316, right vertical side 318, bottom left corner 320, bottom right corner 322, away left vertical crease 324, away right vertical crease 326, away middle vertical crease 328, away bottom horizontal crease 330, away top horizontal crease 384, left intersection 332, right intersection 334, middle intersection 336, toward right side crease 338, toward left side crease 340, right side terminus 342, left side terminus 344, toward first diagonal crease 346, toward second diagonal crease 348, toward third diagonal crease 350, toward fourth diagonal crease 352, front panel flange crease 356, front panel flange intersection 358, front panel flange interior 364, bottom panel flange 372, and bottom panel flange interior 376.

Each of FIG. 2A-2C and their mirror images show a different configuration for where the adhesive seam will be. In FIG. 2A, the adhesive seam will be in the middle of the side panel. In FIG. 2B, the adhesive seam is between a side panel and a front panel, with the front panel flange extending from a front panel and adhering to a side panel. In FIG. 2C, the adhesive seam is again between a side panel a front panel, this time with the front panel flange extending from a side panel and adhering to a front panel. FIG. 2A and FIG. 2B were arbitrarily selected to also show front panel flange adhesive 360 on front panel flange interior 364. Front panel flange adhesive 360 may also be on the front panel flange exterior, not shown, but understood to be the other side of front panel flange interior 364 that is shown.

The embodiment shown in FIG. 2A includes away fourth vertical crease 366 and fourth intersection 368. In this embodiment, right side crease 338 and front panel crease 356 are the same crease, therefore front panel crease 356 is a toward crease. Also shown is toward partial diagonal crease 354, which is necessary on the front panel flange so that it will conform with fourth diagonal crease 352. The embodiment shown in FIG. 2B also includes fifth intersection 370 where front panel flange crease 356, which is a toward crease in this embodiment, meets bottom horizontal crease 330. This embodiment also includes a toward partial diagonal crease 354. The embodiment shown in FIG. 2C also includes fifth intersection 370, but does not include partial diagonal crease 354 because there is no corresponding diagonal crease to mesh with. It is understood that the mirror images of each of the embodiments shown in FIGS. 2A-2C include alternate embodiments of creased paper 310 of the present invention.

Although bottom panel flange 372 is always depicted on the right, it is understood that bottom panel flange 372 could also be on the left or either on the left or right of the mirror images of FIGS. 2A-2C.

Now referring to FIG. 3, bottom reinforcement 386 is shown. Bottom reinforcement 386 is equal in area to the sum of areas 389 and 391, or twice the area of 389 or 391 alone. Bottom reinforcement 386 is integral at bottom reinforcement crease 390 to bottom reinforcement flange 388. Bottom reinforcement crease 390 is an away crease conforming with bottom horizontal crease 330. Bottom reinforcement flange 388 is adhered just above bottom horizontal crease 330 to the interior of what will be a front panel of the assembled bag. Bottom reinforcement 386 is shown in FIG. 3 as being transparent in order to show details behind bottom reinforcement 386, such as bottom reinforcement flange 388 and its position, but it is understood that bottom reinforcement 386 is not necessarily transparent.

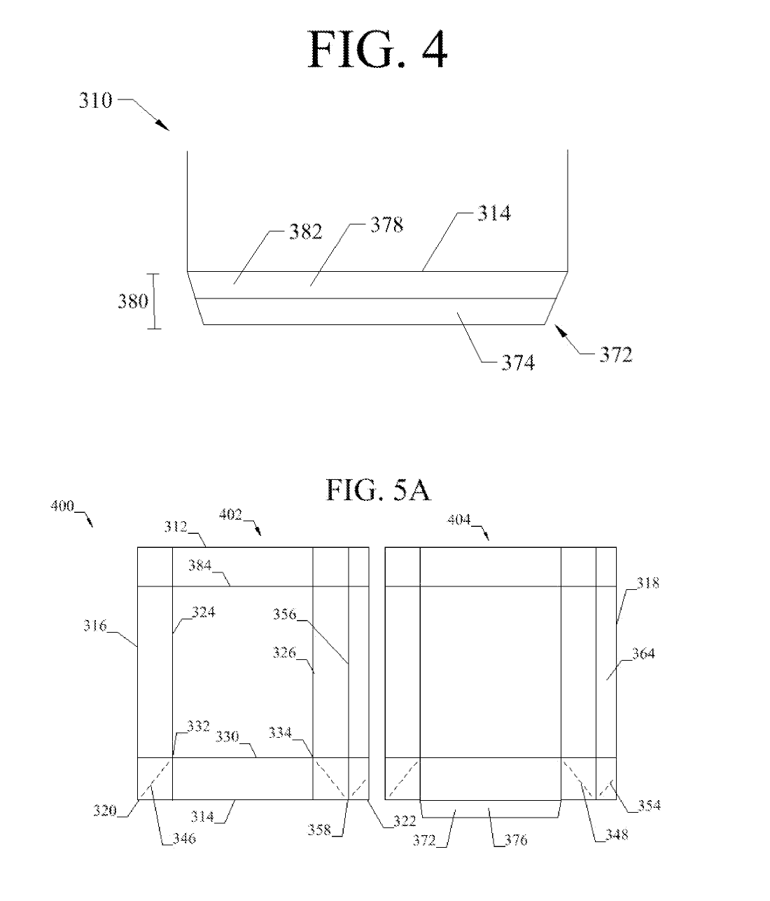

Now referring to FIG. 4, details of preferred bottom panel flange 372 are shown. Exterior side 374 of bottom panel flange 372 is shown as including bottom panel flange adhesive 378. In this embodiment, bottom panel flange adhesive 378 is adhesive strip 382. Bottom panel flange 372 has a width 380 that is greater than adhesive strip 382 so that any seeping adhesive seeps onto bottom panel flange 372, rather than onto exterior 84 of bag 100, discussed below. Adhesive strip 382 is positioned directly under bottom horizontal side 314.

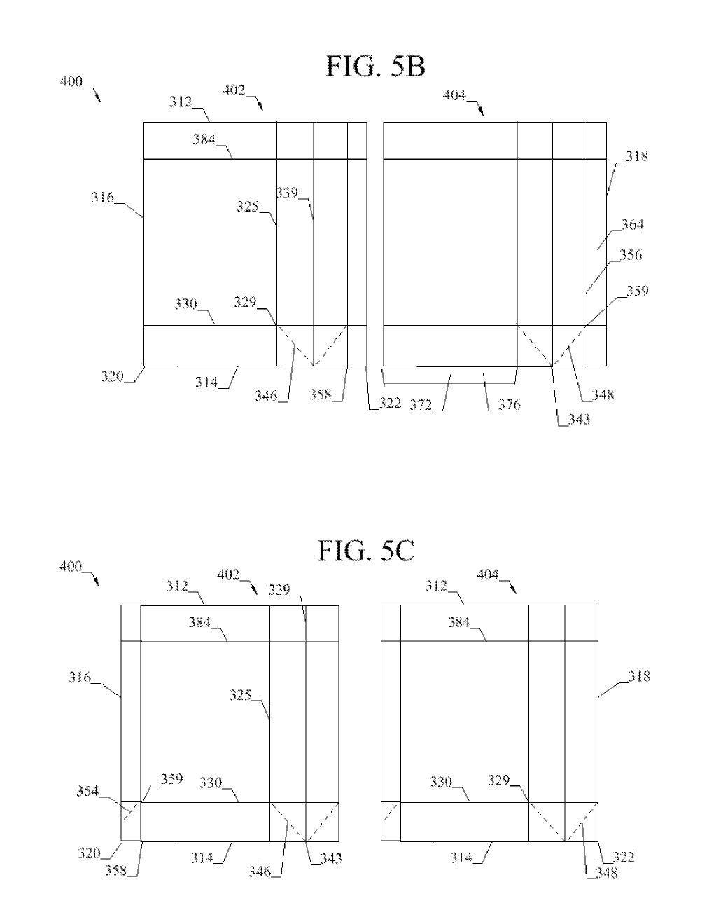

Now referring to FIGS. 5A-5C, several embodiments of the two piece creased paper kit 400 of the present invention is shown. Creased paper kit 400 includes first piece 402 and second piece 404, which are identical to each other. Like reference numbers discussed above identify like features in creased paper kit 400. Creased paper kit 400 will have two adhesive seams where first and second pieces 402, 404 are adhered together. It is understood that front panel crease 356 may be on the right or left of each piece 402, 404. The embodiment shown in FIG.5A includes right and left vertical creases 326, 324. Left vertical crease 324 is adjacent to left vertical side 316 and right vertical crease 326. Right vertical crease 326 is adjacent on the other side to front panel flange crease 346. Front panel flange crease 346 is adjacent on the other side to right vertical side 318. In this embodiment, the adhesive seams will be in the middle of the side panels. As the front panel flange will be adhering to part of a side panel, the front panel flange includes partial diagonal creases 354. The mirror image of this embodiment is an alternative embodiment.

The embodiment shown in FIG. 5B includes only one vertical crease 325 with intersection 329, and also includes one side crease 339, with a side crease terminus 343, and a sixth intersection 359 where left vertical side 316 meets bottom horizontal crease 330. Left vertical side 316 is adjacent to vertical crease 325, which is adjacent on the other side to side crease 339, which is adjacent on the other side to front panel flange crease 356, which is adjacent on the other side to right vertical side 318. In this embodiment the adhesive seams will be between side and front panels. As the front panel flange extends from side panels for adhesion to front panels, no partial diagonal creases 354 are included in this embodiment. First diagonal crease 346 spans between intersection 329 and side crease terminus 343. Second diagonal crease 348 spans between side crease terminus 343 and sixth intersection 359. The mirror image of this embodiment is an alternative embodiment.

The embodiment shown in FIG. 5C includes only one vertical crease 325 with intersection 329, and also includes one side crease 339, with a side crease terminus 343, and a sixth intersection 359 where left vertical side 316 meets bottom horizontal crease 330. Left vertical side 316 is adjacent to front panel flange crease 356, which is adjacent on the other side to vertical crease 325, which is adjacent on the other side to side crease 339, which is adjacent on the other side right vertical side 318. In this embodiment the adhesive seams will be between side and front panels. As the front panel flange extends from front panels for adhesion to side panels, partial diagonal creases 354 are included in this embodiment. First diagonal crease 346 spans between intersection 329 and side crease terminus 343. Second diagonal crease 348 spans between side crease terminus 343 and the intersection of right vertical side 318 and bottom horizontal crease 330. The mirror image of this embodiment is an alternative embodiment.

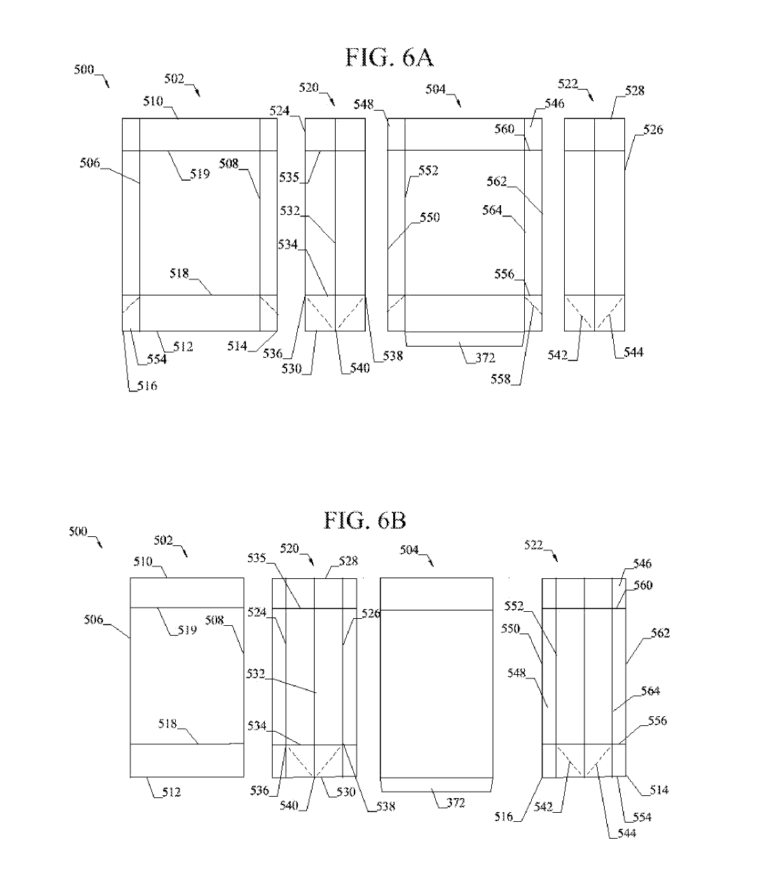

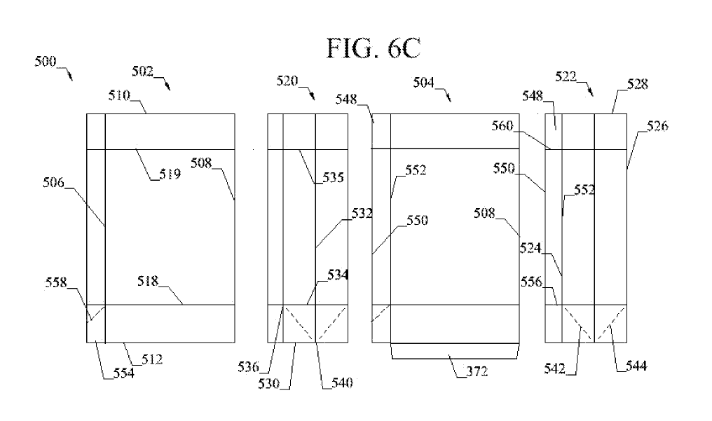

Now referring to FIGS. 6A-6C, the four piece creased paper kit 500 of the present invention is shown. The embodiments of creased paper kit 500 shown in FIGS. 6A and 6B include first and second panel pieces 502, 504, first and second side pieces 520, 522, and two sets of right and left attachment flanges 546, 548. Attachment flanges 546, 548 may be attached to panel pieces 502, 504, as shown in FIG. 6A, or side pieces 520, 522, as shown in 6B. Whether or not attachment flanges 546, 548 are integral to them, panel pieces 502, 504 each include left vertical side 506, right vertical side 508, top horizontal side 510, bottom horizontal side 512, bottom horizontal crease 518, top horizontal crease 519, left intersection 511, and right intersection 513. Whether or not attachment flanges 546, 548 are integral to them, side pieces 520, 522 each include left vertical side 524, right vertical side 526, top horizontal side 528, bottom horizontal side 530, vertical crease 532, bottom horizontal crease 534, top horizontal crease 535, left intersection 536, right intersection 538, vertical crease terminus 540, left diagonal crease 542, and right diagonal crease 544.

Each attachment flange 546, 548 includes bottom horizontal side 554, bottom horizontal crease 556, and top horizontal crease 560. Left attachment flange 548 also includes left vertical side 550, right attachment side 552, and bottom left corner 516. When left attachment flanges 548 are integral to panel pieces 502, 504, as shown in FIG. 6A, right attachment sides 552 of left attachment flanges 548 form away creases with left vertical sides 506 of panel pieces 502, 504. When left attachment flanges 548 are integral to side pieces 520, 522, as shown in FIG. 6B, right attachment sides 552 of left attachment flanges 548 form away creases with left vertical sides 524 of side pieces 520, 522. Right attachment flange 546 also includes right vertical side 562, left attachment side 564, and bottom right corner 514. When right attachment flanges 546 are integral to panel pieces 502, 504, as shown in FIG. 6A, left attachment sides 564 of right attachment flanges 546 form away creases with left vertical sides 506 of panel pieces 502, 504. When right attachment flanges 546 are integral to side pieces 520, 522, as shown in FIG. 6B, left attachment sides 564 of right attachment flanges 546 form away creases with left vertical sides 524 of side pieces 520, 522. The embodiment shown in FIG. 6A, where attachment flanges 546, 548 are integral to panel pieces 502, 504, includes partial diagonal creases 558.

The embodiment shown in FIG. 6C includes four left attachment flanges 548, attached to the left vertical sides 506, 524 of first and second front pieces 502, 504 and third and fourth side pieces 520, 522. In this embodiment, the left attachment flanges 548 integral to first and second front pieces 502, 504 include partial diagonal creases 558. This embodiment includes no right attachment flanges 546. The mirror image of this embodiment, including four right attachment flanges 546, and no left attachment flanges 548, is also included within the present invention.

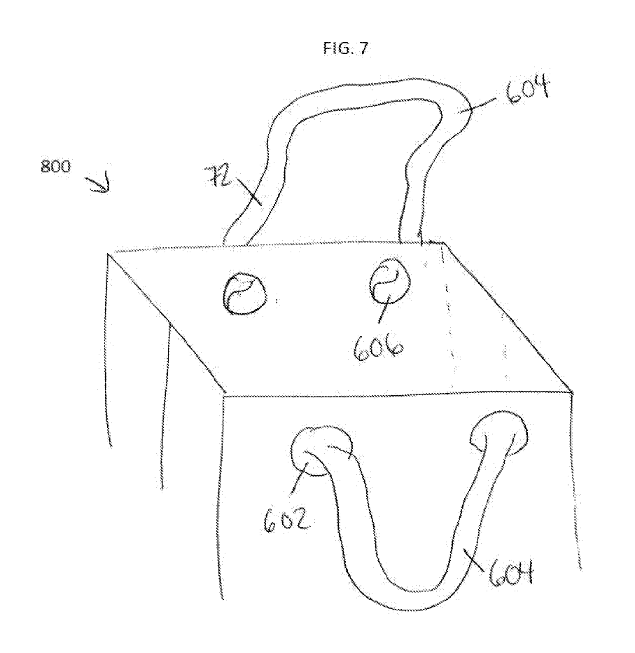

Now referring to FIG. 7, preferred handles 72 are shown. Handles 72 are included in preferred embodiments of the unassembled bag of the present invention. Handles 72 are made of two pieces of string 604 that include knots 606 to hold them in place. Holes 602 are cut through the folded over tops of front panels 18, 20 and top reinforcements 62 that are adhered thereto. Strings 604 are then threaded through holes 602 with knots 606 positioned on interior 86 of bag 100. In some embodiments, knots 606 are positioned on exterior 84 of bag 100.

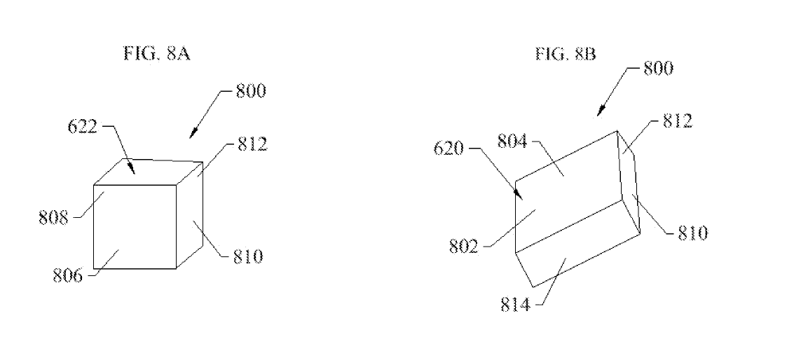

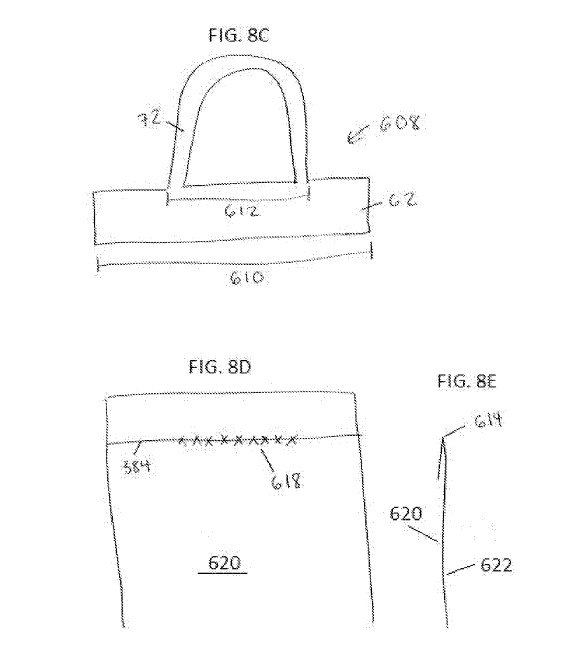

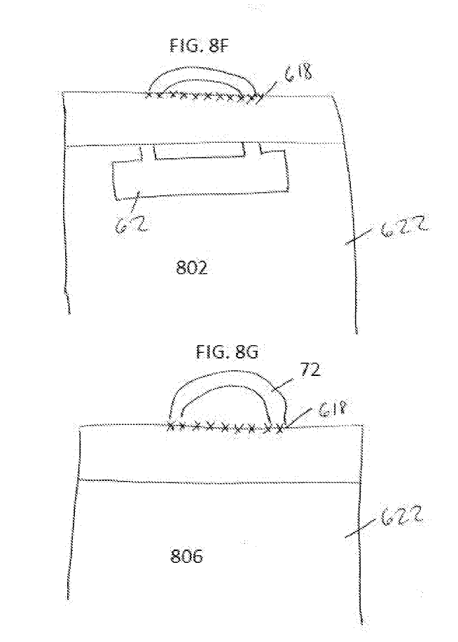

Now referring to FIGS. 8A-8B, bag 800 of the present invention is shown before it is folded down. Bag 800 includes interior 620, exterior 622, front and back panels 802, 806, side panels 810, and bottom panel 814. Front, back, and side panels 802, 806, 810 each include top sections 804, 808, 812 that are folded down to form top folds 614, as shown in FIG. 8E. Top folds 614 are along top horizontal crease 384, as discussed above with reference to the unassembled bag and creased paper kits 400, 500 of the present invention.

Now referring to FIGS. 8C-8G, preferred handles 72 for bag 800 are shown. In this embodiment, top reinforcements 62 are not adhered to bag 800. Instead top reinforcements 62 are integral with handles 72 forming integrated handle and top reinforcement 608 with top reinforcement section 62 and handle section 72. Integrated handle and top reinforcement 608 has a top reinforcement width 610 and a handle width 612. Integrated handle and top reinforcement 608 slips through centered slit 618, shown in hash marks, which is positioned on top folds 614. FIG. 8F shows integrated handle and top reinforcement 608 partially tucked into interior side 622 of front panel 802, with only part of handle section 72 protruding through centered slit 618. FIG. 8G shows integrated handle and top reinforcement 608 in position for use with bag 800 with handle section 72 fully protruding out of centered slit 618 and top reinforcement section 62 tucked under top fold 614 and therefore not visible. Centered slit 618 must be at least as wide as handle width 612 to allow handle section 72 of integrated handle and top reinforcement 608 to move through centered slit 618 unobstructed, but also narrower than top reinforcement width 610 so that the top reinforcement section 62 of integrated handle and top reinforcement 608 will not be able to get through centered slit 618 and will be caught by centered slit 618. Although top reinforcement width 610 is shown as being not as wide as front panel 14, it is understood that top reinforcement width 610 may be as wide as front panel 14. This handle configuration may be used with any of the unassembled bags of the present invention, as described with reference to FIGS. 2A-6C.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

We claim:

1. An unassembled bag capable of being assembled into a bag, comprising:
a sheet of creased paper comprising:
a top horizontal side and a bottom horizontal side, wherein said top horizontal side is parallel to said bottom horizontal side;
a left vertical side and a right vertical side, wherein said right vertical side is parallel to said left vertical side, and wherein said top and bottom horizontal sides are perpendicular to said right and left vertical sides;
a bottom left corner where said left vertical side and said bottom horizontal side meet and a bottom right corner where said right vertical side and said bottom horizontal side meet;
a left vertical crease, a right vertical crease, and a middle vertical crease, wherein said left, right, and middle vertical creases are parallel and parallel to said right and left vertical sides, and are away creases, and said middle vertical crease is between said left and right vertical creases;
a bottom horizontal crease perpendicular to said left, right, and middle vertical creases and adjacent to said bottom horizontal side, wherein said horizontal crease is an away crease;
a top horizontal crease parallel to said bottom horizontal crease and adjacent to said top horizontal side and said bottom horizontal crease;
a left, right, and middle intersection where said left, right, and middle vertical creases and said bottom horizontal crease meet, respectively;
a right side crease and a left side crease, wherein said right and left side creases are parallel to said left, right, and middle vertical creases and perpendicular to said bottom horizontal crease, wherein said left and right side creases are toward creases;
a right side crease terminus where said right side crease and said bottom horizontal side meet and a left side crease terminus where said left side crease and said bottom horizontal side meet;
a first, second, third, and fourth diagonal crease, each of which span diagonally between said bottom horizontal crease and said bottom horizontal side, and each of which is a toward crease; and
a front panel flange crease parallel to and adjacent to one of said left and right vertical sides and a front panel flange intersection where said front panel flange crease and said bottom horizontal side meet: and
an adhesive disposed upon said sheet of paper;
wherein said front panel flange crease, said top and bottom horizontal sides, and the one of said left and right vertical sides to which said front panel flange crease is adjacent define a front panel flange;
wherein said front panel flange comprises a front panel flange interior and a front panel flange exterior; and
wherein said adhesive is disposed upon one of said front panel flange interior and said front panel flange exterior.

2. The unassembled bag as claimed in claim 1, further comprising a bottom reinforcement, a bottom reinforcement flange, and a bottom reinforcement crease disposed between said bottom reinforcement and said bottom reinforcement flange;
wherein said bottom reinforcement is dimensioned to extend over substantially twice an area defined by said bottom horizontal crease, said middle vertical crease, said bottom horizontal side, and one of the group consisting of said right vertical crease and said left vertical crease when said middle vertical crease is adjacent to said one of said group;
wherein said bottom reinforcement flange is integral to said bottom reinforcement and adhered to an area adjacent to and above said bottom horizontal crease; and
wherein said bottom reinforcement crease is an away crease and aligns with said bottom horizontal crease of said sheet of paper.

3. The unassembled bag as claimed in claim 1, wherein said sheet of creased paper further comprises a fourth vertical crease, wherein said fourth vertical crease is adjacent and parallel to said left vertical side and said left vertical crease, and is an away crease, and a fourth intersection where said fourth vertical crease meets said bottom horizontal crease:
wherein said right side crease is said front panel flange crease and is adjacent to said right vertical side and said right vertical crease;
wherein said first diagonal crease spans between said bottom left corner and said fourth intersection; said second diagonal crease spans between said left intersection and said left side crease terminus; said third diagonal crease spans between said middle intersection and said left side crease terminus; and said fourth diagonal crease spans between said right intersection and said front panel flange intersection; and
wherein a space defined by said bottom horizontal side, said right vertical side, said bottom horizontal crease, and said front panel flange crease comprises a partial toward crease spanning between said front panel flange intersection and a location on said right vertical side between said bottom right corner and said bottom horizontal crease.

4. The unassembled bag as claimed in claim 1, wherein said creased sheet of paper further comprises a fourth vertical crease, wherein said fourth vertical crease is adjacent and parallel to said right vertical side and said right vertical crease, and is an away crease, and a fourth intersection where said fourth vertical crease meets said bottom horizontal crease:
wherein said left side crease is said front panel flange crease and is adjacent to said left vertical side and said left vertical crease;
wherein said first diagonal crease spans between said bottom right corner and said fourth intersection; said second diagonal crease spans between said right intersection and said right side crease terminus; said third diagonal crease spans between said middle intersection and said right side crease terminus; and said fourth diagonal crease spans between said left intersection and said front panel flange intersection; and
wherein a space defined by said bottom horizontal side, said left vertical side, said bottom horizontal crease, and said front panel flange crease comprises a partial toward crease spanning between said front panel flange intersection and a location on said left vertical side between said bottom left corner and said bottom horizontal crease.

5. The unassembled bag as claimed in claim 1, wherein said creased sheet of paper further comprises a fifth intersection where said front panel flange crease and said bottom horizontal crease meet, wherein:
said front panel flap crease is adjacent to said left vertical side and said left vertical crease, and is an away crease;
said right side crease is adjacent to said right vertical crease and said right vertical side;
said first diagonal crease spans between said left intersection and said left side crease terminus; said second diagonal crease spans between said middle intersection and said left side crease terminus; said third diagonal crease spans between said third intersection and said right side crease terminus; and said fourth diagonal crease spans between said right side crease terminus and an intersection between said right vertical side and said bottom horizontal crease; and
a space defined by said bottom horizontal side, said left vertical side, said bottom horizontal crease, and said front panel flange crease comprises a partial toward crease spanning between said fifth intersection and a location on said left vertical side between said bottom left corner and said bottom horizontal crease.

6. The unassembled bag as claimed in claim 1, wherein said creased sheet of paper further comprises a fifth intersection where said front panel flange crease and said bottom horizontal crease meet, wherein:
said front panel flap crease is adjacent to said right vertical side and said right vertical crease, and is an away crease;
said left side crease is adjacent to said left vertical crease and said left vertical side;
said first diagonal crease spans between said right intersection and said right side crease terminus; said second diagonal crease spans between said middle intersection and said right side crease terminus; said third diagonal crease spans between said left intersection and said left side crease terminus; and said fourth diagonal crease spans between said left side crease terminus and an intersection between said left vertical side and said bottom horizontal crease; and
a space defined by said bottom horizontal side, said right vertical side, said bottom horizontal crease, and said front panel flange crease comprises a partial toward crease spanning between said fifth intersection and a location on said right vertical side between said bottom right corner and said bottom horizontal crease.

7. The unassembled bag as claimed in claim 1, wherein said creased sheet of paper further comprises a fifth intersection where said front panel flange crease and said bottom horizontal crease meet, wherein:
said front panel flange crease is parallel and adjacent to said right side crease and said right vertical side, and is an away crease;
said left vertical crease is adjacent to said left vertical side and said left side crease; and
said first diagonal crease spans between said left intersection and said left side crease terminus; said second diagonal crease spans between said middle intersection and said left side crease terminus; said third diagonal crease spans between said right intersection and said right side crease terminus; and said fourth diagonal crease spans between said right side crease terminus and said fifth intersection.

8. The unassembled bag as claimed in claim 1, wherein said creased sheet of paper further comprises a fifth intersection where said front panel flange crease and said bottom horizontal crease meet, wherein:
said front panel flange crease is parallel and adjacent to said left side crease and said left vertical side, and is an away crease;
said right vertical crease is adjacent to said right vertical side and said right side crease; and
said first diagonal crease spans between said right intersection and said right side crease terminus; said second diagonal crease spans between said middle intersection and said right side crease terminus; said third diagonal crease spans between said left intersection and said left side crease terminus; and said fourth diagonal crease spans between said left side crease terminus and said fifth intersection.

9. The unassembled bag as claimed in claim 1, wherein said creased sheet of paper further comprises a bottom panel flange protruding from said bottom horizontal side, wherein said bottom panel flange comprises an exterior side and an interior side and one of said exterior side and said interior side comprises a bottom panel flange adhesive.

10. The unassembled bag as claimed in claim 9, wherein said bottom panel flange protrudes from said bottom horizontal side between said middle vertical crease and one of a group consisting of said right vertical crease and said left vertical crease, when said middle vertical crease is adjacent to said one of said group.

11. The unassembled bag as claimed in claim 9, wherein said bottom panel flange protrudes from said bottom horizontal side between one of a first group consisting of said left vertical crease and said right vertical crease, and one of a second group consisting of said left vertical side and said right vertical side, when said one of said first group is adjacent to said one of said second group.

12. The unassembled bag as claimed in claim 9, wherein said bottom panel flange protrudes from said bottom horizontal side between said front panel flange crease and one of the group consisting of said left vertical crease and said right vertical crease, when said front panel flange crease is adjacent to said one of said group.

13. The unassembled bag as claimed in claim 9, wherein said creased sheet of paper further comprises a fourth vertical crease adjacent to one of a first group consisting of said right vertical side and said left vertical side, and adjacent to one of a second group consisting of said right vertical crease and said left vertical crease, wherein said bottom panel flange protrudes from said bottom horizontal side between said fourth vertical crease and said one of said second group.

14. The unassembled bag as claimed in claim 9, wherein:
said bottom panel flange of said creased sheet of comprises a width;
said adhesive is a bottom panel flange adhesive and is disposed on said exterior of said bottom panel flange;
said bottom panel flange adhesive is an adhesive strip; and
said adhesive strip has a width that is narrower than said width of said bottom panel flange and is disposed adjacent to said bottom horizontal side on said bottom panel flange.

15. The unassembled bag as claimed in claim 1, wherein said first, second, third, and fourth diagonal creases of said creased sheet of paper are perforated.

16. The unassembled bag as claimed in claim 1, further comprising:
at least one top reinforcement, wherein said at least one top reinforcement is no larger than an area defined by said top horizontal crease, said middle vertical crease, said top horizontal side, and one of a group consisting of said right vertical crease and said left vertical crease when said middle vertical crease is adjacent to said one of said group; and
at least two handles.

17. The unassembled bag as claimed in claim 16:
wherein said top horizontal crease comprises two centered slits;
wherein said at least one top reinforcement is two top reinforcements, said at least two handles are two handles, and said two top reinforcements are integral with said two handles forming two integrated handle and top reinforcements, each of which comprises:
a handle section;
a top reinforcement section;
a handle width; and
a top reinforcement width, wherein said centered slit is at least as wide as said handle width and less wide than said top reinforcement width.

18. An unassembled bag capable of being assembled into a bag, comprising:
a first sheet of creased paper and a second sheet of creased paper, each of which comprises:
a left vertical side, a right vertical side, a top horizontal side, and a bottom horizontal side;
a bottom right corner at the intersection of said right vertical side and said bottom horizontal side;
a bottom left corner at the intersection of said left vertical side and said bottom horizontal side;
at least one vertical crease that is an away crease;
a bottom horizontal crease that is an away crease;
a top horizontal crease that is an away crease;
at least one intersection at an intersection of said vertical crease and said bottom horizontal crease;
a front panel flange crease adjacent to one of a group consisting of said right vertical side and said left vertical side, wherein said front panel flange crease is a toward crease;
a front panel flange intersection at an intersection of said front panel flange crease and said bottom horizontal side; and
a first and a second diagonal crease spanning diagonally between said bottom horizontal crease and said bottom horizontal side, that are toward creases; and
a bottom panel flange integral to one of said first piece and said second piece, adjacent to said bottom horizontal side.

19. The unassembled bag as claimed in claim 18, wherein each of said first and second sheets of creased paper further comprises a side crease parallel to said at least one vertical crease, a side crease terminus where said side crease meets said bottom horizontal side, and a sixth intersection where said front panel flange crease meets said bottom horizontal crease; and
wherein in each of said first and second sheets of creased paper:
said at least one vertical crease is adjacent to said left vertical side and said side crease;
said front panel flange crease is adjacent to said side crease and said right vertical side;
said first diagonal crease spans between said intersection and said side crease terminus; and
said second diagonal crease spans between said side crease terminus and said sixth intersection.

20. The unassembled bag as claimed in claim 18, wherein each of said first and second sheets of creased paper further comprises a side crease parallel to said at least one vertical crease, a side crease terminus where said side crease meets said bottom horizontal side, and a sixth intersection where said front panel flange crease meets said bottom horizontal crease,
wherein in each of said first and second sheets of creased paper:
said at least one vertical crease is adjacent to said right vertical side and said side crease;
said front panel flange crease is adjacent to said side crease and said left vertical side;
said first diagonal crease spans between said intersection and said side crease terminus; and
said second diagonal crease spans between said side crease terminus and said sixth intersection.

21. The unassembled bag as claimed in claim 18, wherein each of said first and second sheets of creased paper further comprises a side crease parallel to said at least one vertical crease, a side crease terminus where said side crease meets said bottom horizontal side, a sixth intersection where said front panel flange crease meets said bottom horizontal crease, and two partial diagonal creases;
wherein in each of said first and second sheets of creased paper:
said at least one vertical crease is adjacent to said side crease and said front panel flange crease;
said front panel flange crease is adjacent to said at least one vertical crease and said left vertical side;
said first diagonal crease spans between said intersection and said side crease terminus;
said second diagonal crease spans between said side crease terminus and an intersection of said right vertical side and said bottom horizontal crease; and
one of said two partial diagonal creases spans between said sixth intersection and a location on said left vertical side between said bottom horizontal crease and said bottom horizontal side.

22. The unassembled bag as claimed in claim 18, wherein each of said first and second sheets of creased paper further comprises a side crease parallel to said at least one vertical crease, a side crease terminus where said side crease meets said bottom horizontal side, a sixth intersection where said front panel flange crease meets said bottom horizontal crease, and two partial diagonal creases;
wherein in each of said first and second sheets of creased paper:
said at least one vertical crease is adjacent to said side crease and said front panel flange crease;
said front panel flange crease is adjacent to said at least one vertical crease and said right vertical side;
said first diagonal crease spans between said intersection and said side crease terminus;
said second diagonal crease spans between said side crease terminus and an intersection of said left vertical side and said bottom horizontal crease; and
one of said two partial diagonal creases spans between said sixth intersection and a location on said right vertical side between said bottom horizontal crease and said bottom horizontal side.

23. The unassembled bag as claimed in claim 18:
wherein each of said first and second sheets of creased paper further comprises a partial diagonal crease; and
wherein in each of said first and second sheets of creased paper:
said at least one vertical crease comprises a right vertical crease and a left vertical crease;
said at least one intersection comprises a right intersection where said right vertical crease meets said bottom horizontal crease, and a left intersection where said left vertical crease meets said bottom horizontal crease;
said front panel flange crease is adjacent to said right vertical side and said right vertical crease;
said first diagonal crease spans between said bottom left corner and said left intersection, and said second diagonal crease spans between said right intersection and said front panel flange intersection; and
one of said partial diagonal creases spans between said front panel flange intersection and a position on said right vertical side between said bottom right corner and said bottom horizontal crease.

24. The unassembled bag as claimed in claim 18:
wherein each of said first and second sheets of creased paper further comprises a partial diagonal crease; and
wherein in each of said first and second sheets of creased paper:
said at least one vertical crease comprises a right vertical crease and a left vertical crease;
said at least one intersection comprises a right intersection where said right vertical crease meets said bottom horizontal crease, and a left intersection where said left vertical crease meets said bottom horizontal crease;
said front panel flange crease is adjacent to said left vertical side and said left vertical crease;
said first diagonal crease spans between said bottom right corner and said right intersection, and said second diagonal crease spans between said left intersection and said front panel flange intersection; and
one of said partial diagonal creases spans between said front panel flange intersection and a position on said left vertical side between said bottom left corner and said bottom horizontal crease.

25. An unassembled bag capable of being assembled into a bag, comprising:
a first panel piece and a second panel piece, each of which comprises a left vertical side, a right vertical side, a top horizontal side, a bottom horizontal side, a bottom right corner, a bottom left corner, a top horizontal crease that is an away crease, and a bottom horizontal crease that is an away crease;
a third side piece and a fourth side piece, each of which comprises:
a left vertical side, a right vertical side, a top horizontal side, a bottom horizontal side, a vertical crease that is a toward crease, a top horizontal crease that is an away crease, and a bottom horizontal crease that is an away crease;
a left intersection at an intersection of said left vertical side and said bottom horizontal crease;
a right intersection at an intersection of said right vertical side and said bottom horizontal crease;
a vertical crease terminus at an intersection of said vertical crease and said bottom horizontal side;
a right diagonal crease spanning between said right intersection and said vertical crease terminus, wherein said right diagonal crease is a toward crease; and
a left diagonal crease spanning between said left intersection and said vertical crease terminus, wherein said left diagonal crease is a toward crease; and
four attachment flanges.

26. The unassembled bag as claimed in claim 25:
wherein each of said four attachment flanges comprises a left vertical side, a right attachment side parallel to said left vertical side, a bottom horizontal side, a top horizontal crease that is an away crease, a bottom horizontal crease that is an away crease, and a bottom left corner;
wherein one of said four attachment flanges is integral to each of said first and second panel pieces and said third and fourth side pieces, such that said left vertical sides of each of said first and second panel pieces and said third and fourth side pieces are said right attachment sides of each of said four attachment flanges, and are creased away; and
wherein said two attachment flanges integral to said first and second panel pieces further comprise partial diagonal creases that are toward creases.

27. The unassembled bag as claimed in claim 25:
wherein each of said four attachment flanges comprises a right vertical side, a left attachment side parallel to said right vertical side, a bottom horizontal side, a top horizontal crease that is an away crease, a bottom horizontal crease that is an away crease, and a bottom right corner;
wherein one of said four attachment flanges is integral to each of said first and second panel pieces and said third and fourth side pieces, such that said right vertical sides of each of said first and second panel pieces and said third and fourth side pieces are said left attachment sides of each of said four attachment flanges, and are creased away; and
wherein said two attachment flanges integral to said first and second panel pieces further comprise partial diagonal creases that are toward creases.

28. The unassembled bag as claimed in claim 25:
wherein said four attachment flanges comprise:
two left attachment flanges, each of which comprises a left vertical side, a right attachment side parallel to said left vertical side, a bottom horizontal side, a top horizontal crease that is an away crease, a bottom horizontal crease that is an away crease, a bottom left corner, and a partial diagonal crease that is a toward crease; and
two right attachment flanges, each of which comprises a right vertical side, a left attachment side parallel to said right vertical side, a bottom horizontal side, a top horizontal crease that is an away crease, a bottom horizontal crease that is an away crease, a bottom right corner, and a partial diagonal crease that is a toward crease;
wherein one of said right attachment flanges and one of said left attachment flanges is integral to each of said first and second panel pieces, such that:
said left vertical sides of each of said first and second panel pieces are said right attachment sides of each of said left attachment flanges, and are creased away;
said right vertical sides of each of said first and second panel pieces are said left attachment sides of each of said right attachment flanges, and are creased away;
said partial diagonal crease of said left attachment flange spans between said left intersection of said first and second panel pieces and a location on said left vertical side of said left attachment flange between said bottom horizontal side and said bottom left corner of said left attachment flange; and
said partial diagonal crease of said right attachment flange spans between said right intersection of said first and second panel pieces and a location on said right vertical side of said right attachment flange between said bottom horizontal side and said bottom right corner of said right attachment flange.

29. The unassembled bag as claimed in claim 25:
wherein said four attachment flanges comprise:
two left attachment flanges, each of which comprises a left vertical side, a right attachment side parallel to said left vertical side, a bottom horizontal side, a top horizontal crease that is an away crease, a bottom horizontal crease that is an away crease, and a bottom left corner; and
two right attachment flanges, each of which comprises a right vertical side, a left attachment side parallel to said right vertical side, a bottom horizontal side, a top horizontal crease that is an away crease, a bottom horizontal crease that is an away crease, and a bottom right corner;
wherein one of said right attachment flanges and one of said left attachment flanges is integral to each of said third and fourth side pieces, such that:
said left vertical sides of each of said third and fourth side pieces are said right attachment sides of each of said left attachment flanges, and are creased away; and
said right vertical sides of each of said third and fourth side pieces are said left attachment sides of each of said right attachment flanges, and are creased away.

30. A paper bag comprising:
an interior and an exterior;
a front panel having a top section;
a back panel having a top section;
two side panels each having a top section and spanning between said front panel and said back panel, wherein said top sections of said front panel, said back panel and said two side panels are folded into said interior of said bag forming top folds, wherein each of said top fold comprises a centered slit;
a bottom panel spanning between said front panel, said back panel, and said two side panels; and
two integrated handle and top reinforcements, each of which comprises:
a handle section;
a top reinforcement section;
a handle width; and
a top reinforcement width;
wherein said centered slit is at least as wide as said handle width and less wide than said top reinforcement width.
